(19) United States
(12) Patent Application Publication
(10) Pub. No.: US 2015/0169537 A1
(43) Pub. Date: Jun. 18, 2015

(54) USING STATISTICAL LANGUAGE MODELS TO IMPROVE TEXT INPUT

(71) Applicant: Nuance Communications, Inc., Burlington, MA (US)

(72) Inventors: Simon Corston, New Westminster (CA); Keith Trnka, Seattle, WA (US); Ethan R. Bradford, Seattle, WA (US); David J. Kay, Seattle, WA (US); Donni McCray, Seattle, WA (US); Gaurav Tandon, Sammamish, WA (US); Erland Unruh, Seattle, WA (US); Wendy Bannister, Edmonds, WA (US)

(73) Assignee: Nuance Communications, Inc., Burlington, MA (US)

(21) Appl. No.: 14/106,635

(22) Filed: Dec. 13, 2013

(51) Int. Cl. G06F 17/27

(52) U.S. Cl. CPC G06F 17/271

(57) ABSTRACT

The present technology describes context based text input, which uses linguistic models based on conditional probabilities to provide meaningful word completion and modification suggestions, such as auto-capitalization, based on previously entered words. The technology may use previously entered left context words to modify a list of candidate words matching a current user input. The left context may include one or more previously input words followed by a space, hyphen, or another word. The technology may then modify the list of candidate words based on one or more conditional probabilities, where the conditional probabilities show a probability of a candidate list modification given a particular left context. The modifying may comprise reordering the list or modifying properties of words on the list such as capitalization. The technology may then display the modified list of candidate words to the user.

### BACKGROUND

Text based communication using mobile devices is increasing. Every day millions of people send text messages and email and even perform traditional document authoring using their mobile devices. As the demand for mobile device text entry increases, mobile device developers face significant challenges providing reliable and efficient text entry. These challenges are compounded by mobile devices' limited processing power, size, and input interfaces.

A number of applications have been developed to address these challenges. One of the first systems was multitap. Multitap divided the alphabet into sets of letters, and assigned each set to a number on the phone's dial pad. The user would repeatedly press the key assigned to the letter they desired to cycle through and select one of the letters for that key. Users of this system found text entry a painstaking process, taking minutes to enter even a few simple words. In answer to the limits of multitap, developers created predictive text entry systems. The T9 system, by Nuance Communications Inc., for example, allowed a single key press for each letter where each key press corresponded to a set of letters. The T9 system determined, for a sequence of letter sets corresponding a sequence of key presses, matching words from a dictionary. The T9 system then ordered matching words based on their frequency of use. While users of this type of predictive text system were generally able to increase text entry speed, they also found the system prone to mistakes as they selected unintended words. Predictive text system users also experienced subjective increased difficulty of entering text, as the user often had to constantly shift focus away from the text entry field and read and consider several words down a list of suggestions for every key press.

Eventually, mobile devices began supporting full keyboards with either physical dedicated buttons or virtual touchscreen interfaces. These systems significantly improved text entry speed as compared to multitap, as a user pressed exactly one button to select a letter. Full keyboards also provided increased accuracy and reduced cognitive load as compared to T9, as unwanted predictions were not present. However, these systems were still prone to user error as the keys were often confined to a small area. Furthermore, these systems required the user to enter the entire word, even though the intended word may be evident. Several systems have attempted to combine aspects of predictive text entry with full keyboards with limited success. However, users of these systems are still faced with lists of suggested words where the intended word can be buried several places down the list.

Accordingly, there exists a need for a system that allows fast, accurate text entry, while lowering the cognitive load imposed on users to sift through unwanted word suggestions.

The need exists for a system that overcomes the above problems, as well as one that provides additional benefits. Overall, the examples herein of some prior or related systems and their associated limitations are intended to be illustrative and not exclusive. Other limitations of existing or prior systems will become apparent to those of skill in the art upon reading the following Detailed Description.

### BRIEF DESCRIPTIONS OF THE DRAWINGS

FIG. 1 is a block diagram illustrating an operating environment for the disclosed technology.

FIG. 2 is a flow diagram illustrating a method for entering text in an input field.

FIG. 3 is a flow diagram illustrating a method for updating a word for a given right context.

FIG. 4 is a flow diagram illustrating a method for updating a candidate word list for a given left context.

FIG. 5 is a flow diagram illustrating a method for creating or updating a context based dictionary.

FIG. 6 is a block diagram illustrating a data structure containing conditional probabilities given a context.

FIG. 7 is a block diagram illustrating a system for entering text in an input field.

### DETAILED DESCRIPTION

The disclosed technology provides context based text input, which uses linguistic models based on conditional probabilities to provide meaningful word completion suggestions and auto-capitalization based on previously entered words. By capitalizing and ordering suggested words in a way that puts more likely candidate words first, the disclosed technology eliminates much of the frustration experienced by users of the prior art and increases text entry speeds while reducing the cognitive load required by prior systems.

A system is described in detail below that employs previously entered or “left context” input to modify a list of candidate words matching a current user input. For example, a method for implementing the disclosed technology may include receiving a left context for an input field. As discussed below, and for languages written from left to right, the left context may include one or more previously input words followed by a space, punctuation (e.g. a hyphen), or another word. Of course, aspects of the invention apply equally to languages written from left to right, top to bottom, etc., and the term “left context” is equally applicable to all such languages, though “right context” or “top context” would be a more apt term for these languages. Nevertheless, for clarity and conciseness reasons, the left-to-right language of English will be used as an example, together with the term “left context.”

The method may also receive a user input corresponding to a part of a word. The word may include another portion different from the part indicated by the user input. The method then retrieves, without first receiving the other portion of the word, a set of one or more candidate words that match the user input. The method may then modify the list of candidate words based on one or more conditional probabilities, where the conditional probabilities show a probability of a candidate list modification given a particular left context. The modifying may comprise reordering the list or modifying properties of words on the list such as capitalization. The method may then display the modified list of candidate words to the user. The method then receives a selection, such as another user input, of one of the words from the modified list of candidate words. The method then enters the selected word in the input field.

By presenting a modified list based on conditional probabilities the system may reduce the cognitive load on the user. The user's intended word may be consistently closer to the top of the suggested words list or may be determined based on fewer entered characters as compared to other text entry systems. Particularly in languages such as German where the average number of characters per word is relatively high, a system that can accurately predict an intended word using fewer letters may significantly reduce the user's cognitive load.

For example, as a user enters the letters “ea” a list of matching candidate words may contain the words “ear” and “earth.” If the previous words entered by the user are “I am on the planet” the suggestion “earth” may be moved above the closest match “ear” because the contextual probability suggests that “earth” is more likely the next word. In a further example, again the user may have entered the letters “ea,” and “The distance from Mars to the” are the previous words entered by the user. In this example, the word “earth” is again more likely than “ear.” However, in this context, the system may determine that, given the use of a capitalized celestial body in the previous five words, “earth” should be capitalized. The system would then suggest “Earth” before “ear” in a list of candidate words.

Overall, variables such as (A), (B), and (X) as used herein indicate one or more of the feature identified without constraining sequence, amount, or duration other than as further defined in this application. Without limiting the scope of this detailed description, examples of systems, apparatus, methods, and their related results according to the embodiments of the present disclosure are given below. Unless otherwise defined, all technical and scientific terms used herein have the same meaning as commonly understood by one of ordinary skill in the art to which this disclosure pertains. In the case of conflict, the present document, including definitions, will control. The terms used in this detailed description generally have their ordinary meanings in the art, within the context of the disclosure, and in the specific context where each term is used. For convenience, certain terms may be emphasized, for example using italics and/or quotation marks. The use of emphasis has no influence on the scope and meaning of a term; the scope and meaning of a term is the same, in the same context, whether or not it is emphasized. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

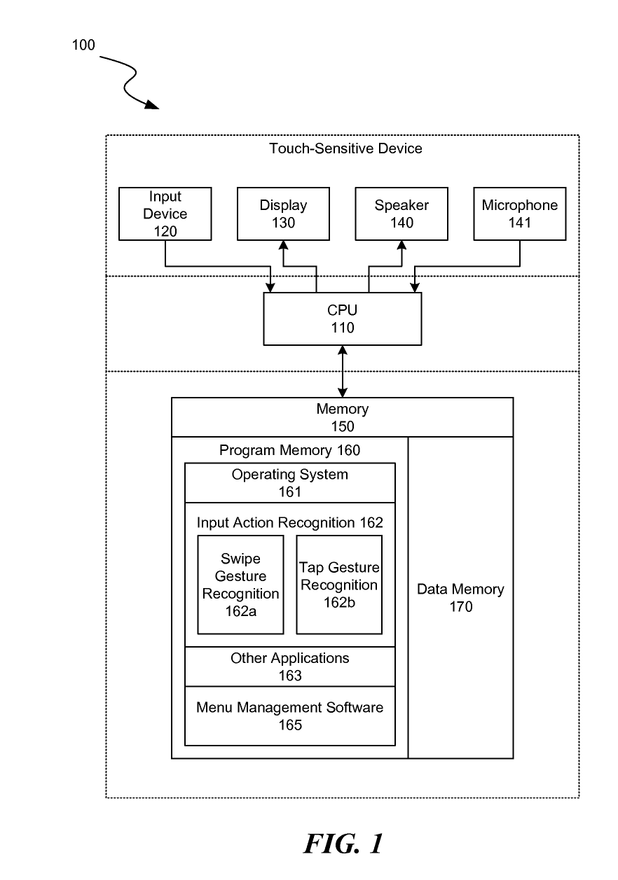

FIG. 1 is a block diagram illustrating an operating environment for the disclosed technology. The operating environment comprises hardware components of a device 100 for implementing a statistical language model text input system. The device 100 includes one or more input devices 120 that provide input to the CPU (processor) 110, notifying it of actions performed by a user, such as a tap or gesture. The actions are typically mediated by a hardware controller that interprets the signals received from the input device and communicates the information to the CPU 110 using a known communication protocol. Input devices 120 include, for example, a capacitive touchscreen, a resistive touchscreen, a surface wave touchscreen, a surface capacitance touchscreen, a projected touchscreen, a mutual capacitance touchscreen, a self-capacitance sensor, an infrared touchscreen, an infrared acrylic projection touchscreen, an optical imaging touchscreen, a touchpad that uses capacitive sensing or conductance sensing, or the like. Other input devices that may employ the present system include wearable input devices with accelerometers (e.g. wearable glove-type input devices), a camera- or image-based input device to receive images of manual user input gestures, and so forth.

The CPU may be a single processing unit or multiple processing units in a device or distributed across multiple devices. Similarly, the CPU 110 communicates with a hardware controller for a display 130 on which text and graphics, such as support lines and an anchor point, are displayed. One example of a display 130 is a display of the touchscreen that provides graphical and textual visual feedback to a user. In some implementations, the display includes the input device as part of the display, such as when the input device is a touchscreen. In some implementations, the display is separate from the input device. For example, a touchpad (or trackpad) may be used as the input device 120, and a separate or standalone display device that is distinct from the input device 120 may be used as the display 130. Examples of standalone display devices are: an LCD display screen, an LED display screen, a projected display (such as a heads-up display device), and so on. Optionally, a speaker 140 is also coupled to the processor so that any appropriate auditory signals can be passed on to the user. For example, device 100 may generate audio corresponding to a selected word. In some implementations, device 100 includes a microphone 141 that is also coupled to the processor so that spoken input can be received from the user.

The processor 110 has access to a memory 150, which may include a combination of temporary and/or permanent storage, and both read-only and writable memory (random access memory or RAM), read-only memory (ROM), writable nonvolatile memory, such as flash memory, hard drives, floppy disks, and so forth. The memory 150 includes program memory 160 that contains all programs and software, such as an operating system 161, input action recognition software 162, and any other application programs 163. The input action recognition software 162 may include input gesture recognition components, such as a swipe gesture recognition portion 162a and a tap gesture recognition portion 162b, though other input components are of course possible. The input action recognition software may include data related to one or more enabled character sets, including character templates (for one or more languages), and software for matching received input with character templates and for performing other functions as described herein. The program memory 160 may also contain menu management software 165 for graphically displaying two or more choices to a user and determining a selection by a user of one of said graphically displayed choices according to the disclosed method. The memory 150 also includes data memory 170 that includes any configuration data, settings, user options and preferences that may be needed by the program memory 160, or any element of the device 100. In some implementations, the memory also includes dynamic template databases to which user/application runtime can add customized templates. The runtime-created dynamic databases can be stored in persistent storage and loaded at a later time.

In some implementations, the device 100 also includes a communication device capable of communicating wirelessly with a base station or access point using a wireless mobile telephone standard, such as the Global System for Mobile Communications (GSM), Long Term Evolution (LTE), IEEE 802.11, or another wireless standard. The communication device may also communicate with another device or a server through a network using, for example, TCP/IP protocols. For example, device 100 may utilize the communication device to offload some processing operations to a more robust system or computer. In other implementations, once the necessary database entries or dictionaries are stored on device 100, device 100 may perform all the functions required to perform context based text entry without reliance on any other computing devices.

Device 100 may include a variety of computer-readable media, e.g., a magnetic storage device, flash drive, RAM, ROM, tape drive, disk, CD, or DVD. Computer-readable media can be any available storage media and include both volatile and nonvolatile media and removable and non-removable media.

The disclosed technology is operational with numerous other general purpose or special purpose computing system environments or configurations. Examples of well-known computing systems, environments, and/or configurations that may be suitable for use with the technology include, but are not limited to, personal computers, server computers, handheld or laptop devices, cellular telephones, tablet devices, multiprocessor systems, microprocessor-based systems, set-top boxes, programmable consumer electronics, network PCs, minicomputers, mainframe computers, distributed computing environments that include any of the above systems or devices, and the like.

It is to be understood that the logic illustrated in each of the following block diagrams and flow diagrams may be altered in a variety of ways. For example, the order of the logic may be rearranged, sub-steps may be performed in parallel, illustrated logic may be omitted, other logic may be included, etc.

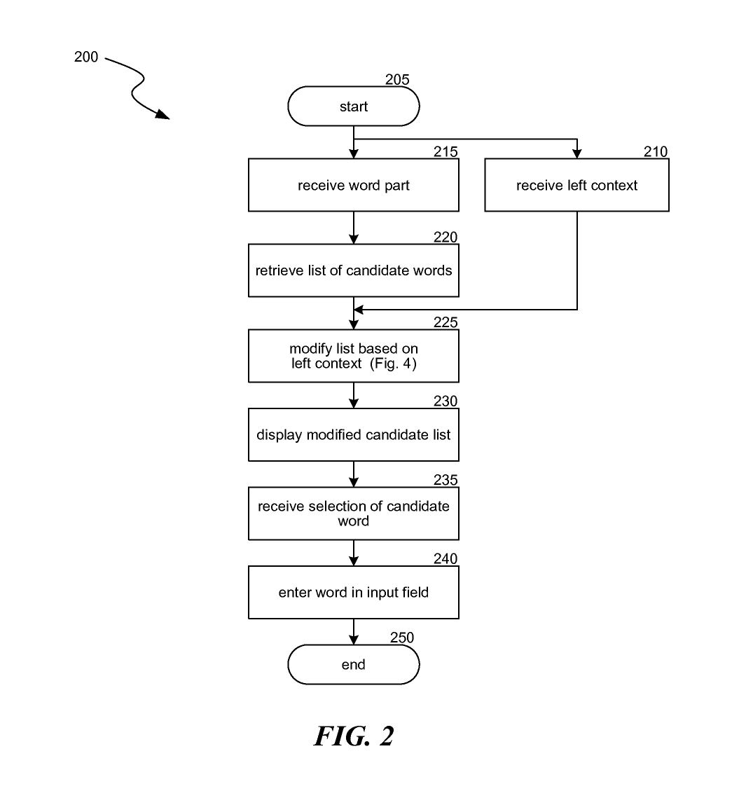

FIG. 2 is a flow diagram illustrating a method 200 for entering text in an input field. The method begins at block 205 and continues to blocks 210 and 215. At block 210 the method receives a left context. As used herein, “left context” refers to a set of one or more words preceding the current user input (or character representing a word or word-portion in a character-based language). A left context may comprise an “n-gram.” In some embodiments the left context will be a consistent number of words entered after the current input. Of course, aspects of the invention apply equally to languages written from left to right, top to bottom, etc., and the term “left context” is equally applicable to all such languages, though “right context” or “top context” would be a more apt term for these languages. Nevertheless, for clarity and conciseness reasons, the left-to-right language of English will be used as an example, together with the term “left context.”

Words in a left context may be any delineated set of one or more characters. In other embodiments the left context may be a variable number of words defined by a delineating event. Such a delineating event may include punctuation, grammatical, linguistic, or formatting events. For example, a left context may include all the previous words until a punctuation mark from a set of punctuation marks is reached (e.g. “. , ; : ? ! { ([ ¶”). In another example, the left context may include the previous words entered until a particular type of word such as a noun or verb is reached. In yet a further example, the left context may include all previous words until a formatting mark such as a section break or tab character is reached.

At block 215 the method receives a user input (A) corresponding to a part of a word. The user input may be received via, for example, a push-button keyboard, a virtual keyboard, a finger or stylus interacting with a touchscreen, an image from a camera, real or virtual buttons on a remote, or input buttons on a device such as a game controller, mobile phone, mp3 player, computing pad, or other device. The part of the word may be separated from the left context received in block 210 by a space, hyphen, or one or more other words. The user input (A) may be a series of key taps, one or more gestures or swipes, motions on a joystick, a spoken command, a visual motion captured by a camera, or any other input from a user indicating one or more letters. The method resolves this user input (A) into the portion of the word comprising one or more letters. In some embodiments, the portion of the word may comprise sets of letters. For example, the user input (A) may comprise a series of key presses, where each key press corresponds to a set of characters.

Next, at block 220, the method retrieves a list of candidate words that match the received portion of the word. The candidate words may be selected from a local database, retrieved from a server, stored in a data structure in memory, or received from any other data source available to the device executing the method. Depending on the form of the portion of the word received in block 220, the system may perform various pre-processing on the portion of the word, such as reordering letters, smoothing gestures, re-sampling an audio signal, and performing other modifications to prepare the portion of a word for comparison to stored data. The method may then compare the portion of a word with the data source to select matches. For example, if the portion of a word comprised the letters “tha” the method may select all words that start with “tha.” As a further example, if the portion of a word is a sequence of letter sets starting with the first set of letters “d, e, c” and followed by the second set of letters “j, u, m, y, h, n” the method may select all words that begin with a letter in the first set and have a letter in the second set as that word's second letter. In some embodiments, the candidate word list may also contain the set of characters corresponding to the user input (A), whether or not they exactly match an entry in the data source. In some embodiments the system may select candidate words from multiple databases or dictionaries. The method then continues to block 225.

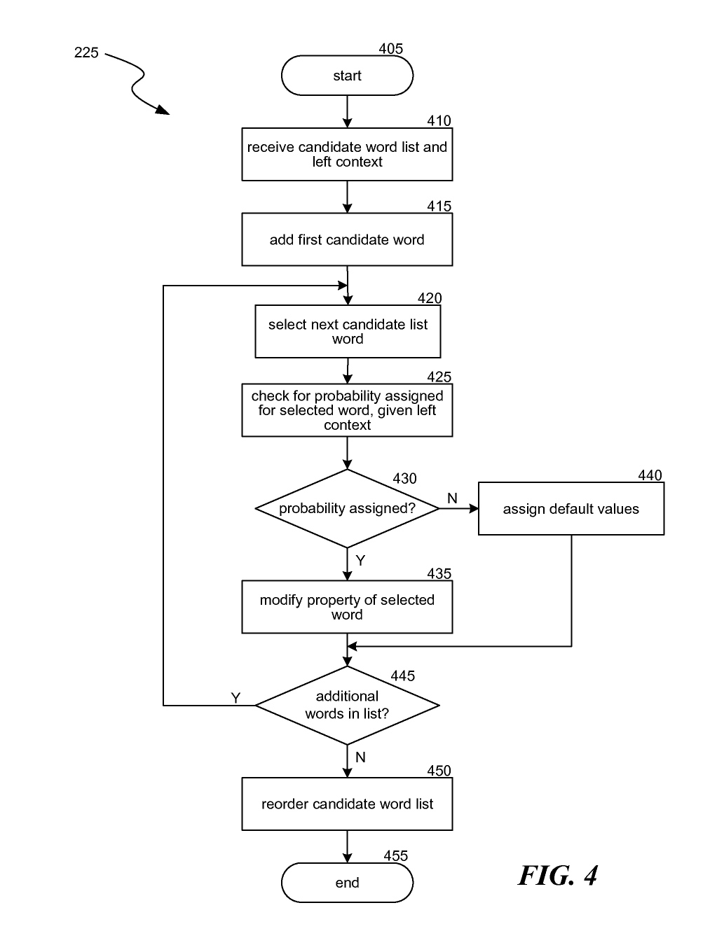

At block 225 the method modifies the list of candidate words based on the received left context. As discussed below in more detail in relation to FIG. 4, the modification may comprise reordering the list or modifying properties of words on the list such as capitalization, spelling, or grammar. In some embodiments, modifications may comprise multiple changes to the properties of words such as in the case of the left context “Is it a Douglas,” if the user next entered “for.” changing “for.” to “Fir?” so the sentence would read “Is it a Douglas Fir?”

At block 230 the method displays the modified list of candidate words. In various embodiments the list may be displayed in a selection menu integrated with a virtual input keyboard, in the text input field, or at a location defined by the start or end of the user input (A). The list of candidate words may be displayed with various formatting indications of modifications. The most probable word may be in a different color or style, or words from a particular dictionary may be in a first color or style while words from another dictionary may be in a different color or style. For example, if the user has two dictionaries enabled for different languages, the words from the user's native language may show up in green while the words from a second language may show up in blue. Additionally, candidate words that include a change to the user input (A) may be shown in a different format. For example, if the modification to the list of candidates resulted in a capitalization of a letter indicated in the user input (A), the capitalized letter may be displayed in a different color, underlined, bold, italic, or in some other manner to indicate to the user that selecting this candidate word will change a letter entered by the user.

The method then continues to block 235 where a user selection from the displayed modified candidate word list is received. In some embodiments, receiving a user selection may comprise automatically selecting the first word in the candidate list based on a pre-determined user input such as a space character or completion gesture. Alternatively or additional, receiving a user selection may comprise tapping on a word in the displayed modified candidate list or using a pointing device, arrow keys, or joystick, or the user selection may comprise a space, punctuation mark, or end gesture, without completing the word entry, signifying a selection of the first candidate word or a most probable candidate word. The method then continues to block 240 where the selected word is entered in the text input field. Entering the selected word may comprise replacing or augmenting one or more characters previously displayed corresponding to the user input (A).

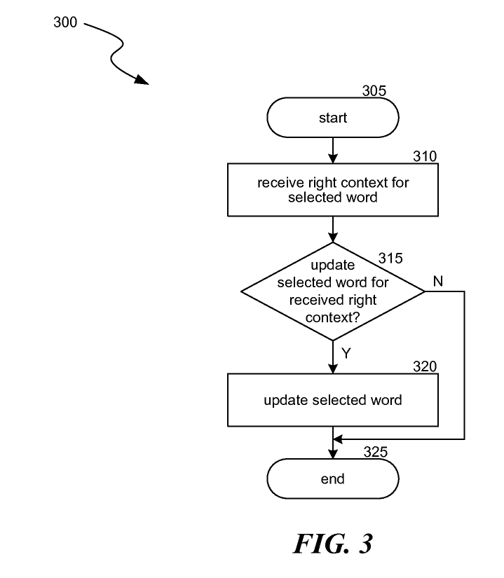

As discussed above in relation to FIG. 2, some embodiments base word suggestions and modifications on previously entered words i.e. the “left context.” In other embodiments, word suggestions or modifications are generated after subsequent words are entered, i.e. the “right context.” FIG. 3 is a flow diagram illustrating a method 300 for updating a word for a given right context. The method begins at block 305. In some embodiments a previously entered word may be automatically modified based on one or more subsequently entered words, referred to herein as a “right context.” Similar to a left context, a right context may comprise a set of one or more words, however, where the left context is a set of previously entered words, the right context is a set of subsequently entered words. For example, if a user enters the word “president” then the next word is “Bush,” the system may modify the word president to be capitalized as “President” based on the right context “Bush.”

Words in a right context may be any delineated set of one or more characters. A right context may comprise an “n-gram.” In some embodiments the right context will be a consistent number of words to the right of the particular word. In other embodiments the right context may be a variable number of words defined by a delineating event. Such a delineating event may include punctuation, grammatical, linguistic, or formatting events. For example, a right context may include all the subsequent words until one of the sets of punctuation marks “. , ; : ? ! } ) ] ¶” is reached. In another example, the right context may include the subsequent words entered until a particular type of word such as a noun or verb is reached. In yet a further example the right context may include all previous words until a formatting mark such as a section break or tab character is reached. The method proceeds from block 305 to block 310 where, for a particular selected word, a right context is received.

The method continues to block 315 where the method determines whether the particular selected word should be updated for the given right context. In some embodiments the method may determine that the particular selected word should be modified due to a particular word being within a certain distance of the right context. For example, if the particular selected word is “national” and the next word is “Academy,” the method may determine that, given this right context, there is a sufficient probability that the intended word was the capitalized version “National” and therefore should be modified. This determination may be based on a set of conditional probabilities for words given a right context, and may be based on the conditional probabilities being above a predetermined threshold, such as 50%, 75%, or 85%. In some embodiments the method may determine that an entered word should be replaced with a different word. For example, a user may enter the word “discus.” If the right (or in some cases left) context does not contain other words or phrases relating to the sport of discus, the system may replace the word with “discuss.”

Updating punctuation based on a right context may be beneficial, particularly if the user is entering text with a language such as French, where the meaning of words are based on punctuation such as accent marks. For example, a user may enter the phrase “Après le repas, commandé ” (After the meal, order) followed by “par mon mari, on rentre.” (by my husband, we'll go home.) In this case, the right context “par mon mari” (by my husband) requires a past participle before it, indicating that the user intended to use an accented version “commandé.” The method may update the sentence to recite “Après le repas, commandé par mon mari, on rentre.” (After the meal, ordered by my husband, we'll go home.) To the contrary, if the right context of “commandé ” had been “le dessert!” (dessert!) the verb commandé, with no accent, is more probable so the method may not update the sentence reading “Après le repas, commandé le dessert!” (After the meal, order dessert!)

The modification of a word based on a right context may include multiple changes such as punctuation and spelling. For example, if a user first entered “My fence” and then entered the right context “and I are getting married.” The method may determine that, based on the five-word right context for “fence” containing a variation of the word “marry,” the probability that the user intended the word fiancé is sufficiently high that the word should be replaced so the sentence would read “My fiancé and I are getting married.”

If the method determines that the particular selected word should not be updated, the method continues to block 325, where it ends. If the system determines that the particular selected word should be modified it continues to block 320. At block 320 the method performs the modification of the particular selected word. Possible modifications include any change to the particular selected word such as capitalization, formatting, spelling corrections, grammar corrections, or word replacement. The method then continues to block 325, where it ends.

FIG. 4 is a flow diagram illustrating a method 225 for updating a candidate word list for a given left context. The method begins at block 405 and continues to block 410. At block 410 the method receives a candidate word list and left context. The candidate word list and left contest are discussed above in relation to FIG. 2. The method then continues to block 415.

At block 415 the method uses, as the first candidate word, the text corresponding to the user's actual input (A), such as a set of key taps or a swipe. In some cases, a user may want to enter text that does not correspond to a word in the dictionary, or is very unlikely in the given context. The method allows the user to enter this type of text by placing the characters corresponding to the user's input (A) as the first entry on the candidate word list, regardless of whether it matches a dictionary entry or left context. In some embodiments the method may provide a different means for allowing a user to enter text that does not match a dictionary entry or may restrict users to dictionary words, and in these embodiments the method skips block 415.

The method next moves to block 420 where it selects the next word in the candidate word list. In the case where this is the first time the method has been at block 420, the method will select the second word of the candidate word list, the word after the entry corresponding to the user's actual input (A). If this is not the method's first time at block 420, the method selects the word after the word selected in the method's previous time at block 420. The method then proceeds to block 425.

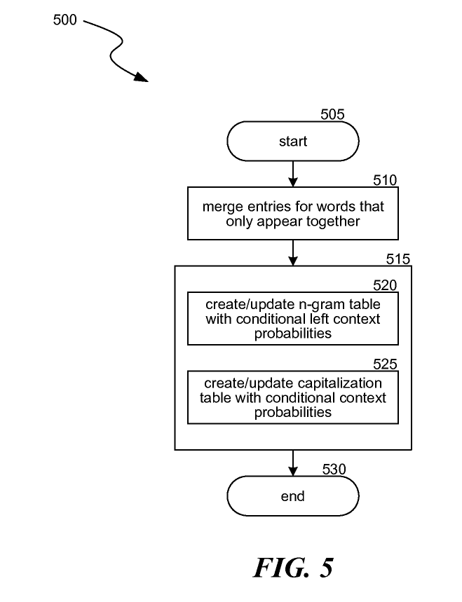

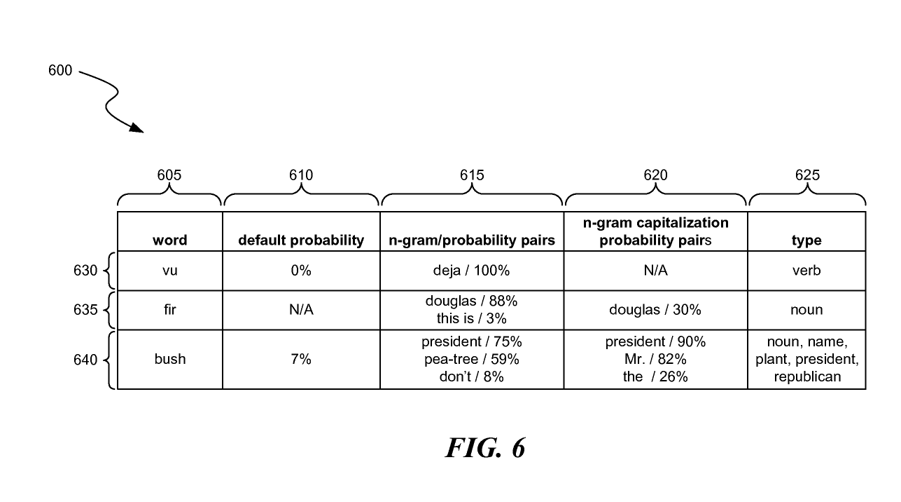

At block 425, the method determines if a conditional probability is assigned for the selected word, given the received left context. As used herein, a conditional probability for a word given a left context includes an estimation that a user intended the word given the left context, expressed as a ratio, percentage, or other value that can be compared to a threshold. A conditional probability may be an estimation that a user intended the word given the preceding word. A conditional probability may be an estimation that a user intended the word given that a word or set of words is in the preceding n-gram. A conditional probability may be an estimation that a user intended the word given that a word or set of words in the preceding n-gram has a certain property such as being capitalized, italicized, plural, singular, or abbreviated. A conditional probability may be an estimation that a user intended the word given that the preceding n-gram uses a particular punctuation. When multiple dictionaries are enabled, a conditional probability may be based on a preferred dictionary, such as the dictionary for the user's native language. Conditional probabilities may be based on known universal or individual usage patterns, grammar, language or dictionary preference, text cadence, or other factors discussed herein. For example, if the left context is “′Yes, let's go!′ he” and the candidate words are matching a user input of “sprout” include “sprouted” and “shouted,” given the “!” in the left context, the word “shouted” may be more likely. These estimations may be of the probability that a user intended a particular version of a word. For example, if the user entered “bush” and the left context is “President,” the estimation may be for the likelihood a user intended the word “Bush.” The creation of conditional probabilities is discussed further in relation to FIGS. 5 and 6.

In block 425, the method may retrieve a set of conditional probabilities for the selected word from a database or other data store. The method may compute conditional probabilities heuristically. For example, the method may determine that for the received left context a particular type of word is expected, such as a verb. The method, in this example, will calculate higher probabilities for verbs than for non-verbs. The method then continues to block 430.

At block 430 the method determines whether a probability has been assigned or calculated for the selected word, given the left context. If not, the method continues to block 440, where, in some embodiments, a default probability is assigned, which may be used for subsequent modification or candidate word list ordering. If, at block 430, the method determines that a probability has been assigned or has been calculated for the selected word the method continues to block 435.

At block 435 the method modifies a property of the selected word based on the probability assigned for the selected word given the left context. In some embodiments this may include assigning value to the word for ordering of the candidate word list. In some embodiments the modification may include changing a word attribute such as capitalization or formatting. The method then continues to block 440.

At block 440 the method determines if additional words are in the candidate word list. If there are additional words in the candidate word list, the method returns to block 420, otherwise the method continues to block 450.

At block 450 the method may reorder the words in the candidate word list based on the probabilities given the current left context. Candidate words may be moved up or down on the candidate word list based on their conditional or default probability. In some embodiments, other actions such as word formatting may be performed in addition to, or in lieu of, word ordering. For example, the most probable word, or words with a conditional probability above a certain threshold, may be written in red. Word ordering may group, or otherwise emphasize or annotate, particular types of words based on a determination that the intended word is likely of that type. For example, if the system determines, based on a left context, that it is 75% likely that the intended word is a verb, all verbs may be italicized. The reordering of the candidate word list may apply to all the words of the candidate word list or may omit the first selected candidate word identified at block 415. The method then continues to block 455, where it returns.

FIG. 5 is a flow diagram illustrating a method 500 for creating or updating a context based dictionary. The method begins at block 505 and continues to block 510. At block 510 the method begins with a standard text entry dictionary and a linguistic model. The linguistic model contains multiple conditional probabilities, as discussed above. The conditional probabilities may be determined from an analysis of a large sample or corpus of electronic text documents. The analysis may review the correspondence of particular words to other immediately preceding words, types of words, or words within a preceding n-gram. The conditional probabilities may also be based on or comprise linguistic rules. The conditional probabilities may show that, for a particular word or word type, it is likely preceded by another type of word. For example, given the dictionary entry “punted,” there may be a linguistic rule that states that in less than 1% of cases do past tense verbs begin a sentence. One of the probabilities for the past tense verb “punted” may comprise this linguistic rule; alternatively, the conditional probability may identify sentence-ending punctuation as a left context with a low probability.

At block 510, the method reviews the beginning dictionary for entries that, based on the linguistic model, only follow particular other entries. For example, the word “Aviv,” in almost all contexts, only follows the word “Tel.” The method will combine, into a single entry, these identified entries. The method then continues to block 515.

Block 515 comprises blocks 520 and 525. At block 520 the method creates or updates an n-gram table in the dictionary with conditional probabilities from the linguistic model. The n-gram table matches word entries in the dictionary to particular n-grams and a corresponding probability for that n-gram, see, for example, items 615 in FIG. 6. At block 525 the method creates or updates a capitalization table in the dictionary with conditional probabilities from the linguistic model; see, for example, item 620 in FIG. 6. The method then continues to block 530, where it returns.

FIG. 6 is a block diagram illustrating an example of a data structure containing conditional probabilities given a context. Row 630 of the data structure is an example of an entry for the word “vu.” Column 605 identifies dictionary entries for given rows. For row 630 the entry is “vu.” In some embodiments, this row may contain an identifier corresponding to a dictionary entry. Column 610 contains default probabilities for the corresponding row word. A default entry may be used when the current left context does not match any left context assigned for this word. For row 630, there is virtually no case in the English language in which the word “vu” is used other than after the word “déjà.” A corresponding default probability of 0% is therefore assigned for row 630. Column 615 contains n-gram probability pairs. As discussed above in relation to FIGS. 4 and 5, this column contains conditional probabilities that a matching word is intended, given a particular n-gram left context. The corresponding probability is the estimated probability that the entry in column 605 for this row was the intended word, given the left context. For row 630, “vu” has an associated n-gram “déjà” with an estimated probability of 100%. This signifies that if the previously entered word is “déjà” the system predicts it is 100% likely that the user intended to enter “vu” next. Column 620 contains n-gram capitalization probability pairs. This column provides estimated probabilities that, given a particular left context, the user intended the corresponding row word to be capitalized. In the case of row 630, there is no entry for this column. This indicates that there is no left context in which the system would automatically capitalize or suggest capitalization of “vu” based on the left context. Column 625 gives a type for the row word. The system may use this value for heuristically determining a conditional probability, such as in the “punted” example above where a linguistic rule assigns a probability for the existence of a particular type of word. For row 630, column 625 has a value “verb” corresponding to “vu” (French for “seen,” in some embodiments this value may be “noun,” as it is generally used as part of the noun “déjàvu”). Column 625 may have other identifiers for the type of word for the row entry such as past/present/future tense, italics, user-defined, compound, or any other values that may be relevant to determining or adjusting a conditional probability heuristically.

The use of rows 635 and 640 will now be discussed as examples. If a user has entered the letters “fi” one of the matching words in a candidate list may be the word “fir,” corresponding to row 635. Looking at column 610, the system may not have seen “fir” enough times in an analysis of other texts to assign it a default probability. From column 615 the system may be able to determine that for the left context word “douglas,” there is an 88% percent likelihood that the intended word was “fir.” However if the left context is “this is” there is only a 3% likelihood that the intended word was “Fir.” In the case of a “this is” left context, another row corresponding to “for” (not shown) may have a much higher conditional probability. From column 620 the system may determine that given the left context “douglas” there is a 30% likelihood that the user intended to capitalize the word “Fir.” From column 625, the system may determine that the word is a noun, so in contexts where a noun is expected there is a higher probability that this is the intended word, instead of, for example “for.”

Database entries may also be used to modify a word based on a right context. Continuing the douglas fir example, a row in the database may correspond to the subject word “douglas” and a right context column (not shown) may contain a right context n-gram “Fir.” When the system identifies an entry of a subject word (“douglas” in this example) followed by a matching right context word (“Fir,”) it may automatically modify the subject word, such as by capitalizing it. In some embodiments, instead of automatically changing the subject word, the suggestion list may be modified to allow the user to select an update to one or more of the previous words. In this example, when the user has entered “douglas” followed by “fir” the suggestion list may contain a suggestion of “Douglas Fir” indicating that selection of this entry will capitalize both words. As another example, the database entry for fence (not shown), in the fence/fiancé example above, may have an entry in the right context column with the word “marry.” This indicates that if the right context of fence contains the word marry, or in some embodiments any version of the word marry, the word fence should be replaced with fiancé or that the context menu for fence offering the suggestion fiancé should be shown.

As another example a candidate word list may contain the word “bush.” The system may therefore review a data structure or database with a row similar to row 640, identified by column 605. The system may determine that a default probability for the word “bush” is 7%. This indicates that, where a system has identified “bush” as a matching word, the system estimates that 7% of the time this is a correct match. The system may base this default probability estimation on selections by the current user or other users, frequency of the word in a given language, or from other probability metrics. From column 615 the system may estimate that, given the left context “president,” the word “bush” is 75% likely, given the left context “pea-tree” the word “bush” is 59% likely, and given the left context “don't” the word “bush” is 8% likely. A different row, such as for “push,” (not shown) may give a higher probability for the left context “don't.” From column 620 the system may estimate that: given the left context “president” there is a 90% chance the matching word “bush” should be capitalized; given the left context “Mr.” there is a 82% chance the matching word “bush” should be capitalized; and given the left context “the” there is a 26% chance the matching word “bush” should be capitalized. In column 625 for row 640 the system may have identifiers for this type of word such as noun or name, or may have more specialized identifiers, such as president, plant, and republican, all of which may be useful for the system to determine a conditional probability given certain left contexts.

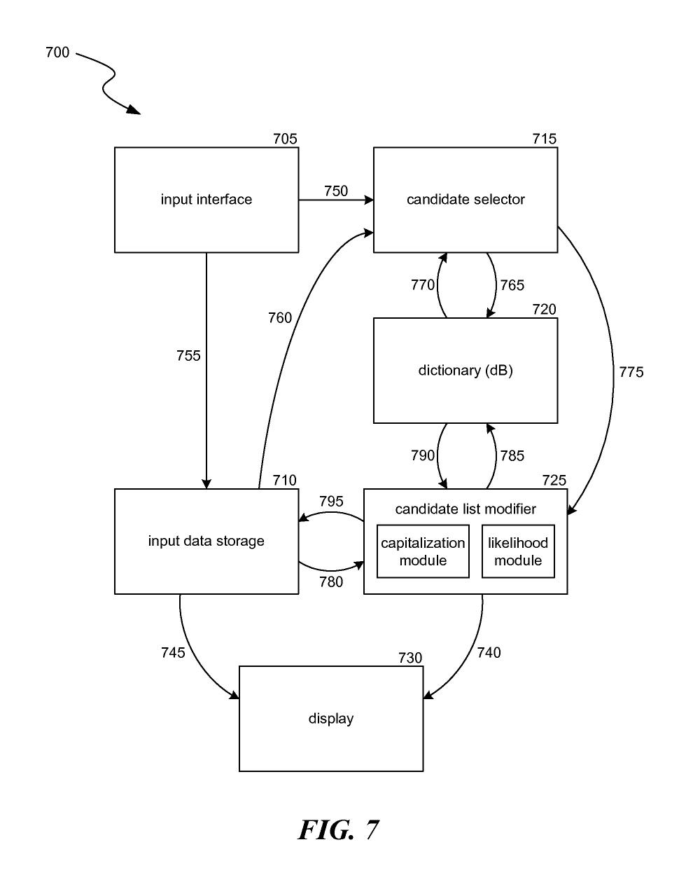

FIG. 7 is a block diagram illustrating a system 700 for entering text in an input field. The system comprises input interface 705, input data storage 710, candidate selector 715, dictionary 720, candidate list modifier 725, and display 730.

The input interface 705 may receive a user input (S) indicating one or more characters of a word. User input (S), or the corresponding characters, may be passed to the input data storage 710 at 755 which adds them to an input structure. The input characters may be passed to the display at 745, which may display the characters.

Candidate selector 715 may receive the user input (S) at 750 and may also receive a context from the input data storage 710 at 760. The candidate selector 715 may then select one or more candidate words based on the user input (S). Candidate selector 715 may generate a request such as a database query to select matching words. The request may be sent to the dictionary 720 at 765. Dictionary 720 may be local or remote, and may be implemented as a database or other data structure. In some embodiments the request for candidate words may also be based on the context received at 760. Dictionary 720 passes candidate words back to the candidate selector at 770. The candidate selector passes the candidate list to the candidate list modifier 725 at 775.

Candidate list modifier 725 receives the candidate list at 775 and a left context at 780. The candidate list modifier generates a request for conditional probabilities for the words in the candidate list given the left context and, at 785, sends the request to the dictionary 720. Dictionary 720, at 790, returns to the candidate list modifier 725 a set of conditional probabilities for the words in the candidate list given the left context. Candidate list modifier 725 then may use the capitalization module to capitalize words in the candidate list that have a conditional probability of being capitalized that is above a predetermined threshold. Candidate list modifier 725 may also use the likelihood module to order words in the candidate list according to values assigned to the words corresponding to conditional probabilities or default values. The candidate list modifier 725 may also receive the user input (S) and place the corresponding characters as the first item in the modified candidate word list. The candidate list modifier 725, at 740, passes the modified list of candidate words to the display 730. A user may enter another user input (T) via the user interface 705, selecting a word from the modified candidate word list. User input (T) may cause the selected word to be entered, at 795, in the input data storage in place of, or by modifying, the input received by the input data storage at 755.

### CONCLUSION

Unless the circumstances clearly require otherwise, throughout the description and the claims, the words “comprise,” “comprising,” and the like are to be construed in an inclusive sense, as opposed to an exclusive or exhaustive sense; that is to say, in the sense of “including, but not limited to.” The words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize.

The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, ¶6 will begin with the words “means for.”) Accordingly, the applicant reserves the right to add additional claims after filing the application to pursue such additional claim forms for other aspects of the invention.

I/We claim:

1. A method of entering text in an input field, the method comprising:
receiving a left context for the input field, wherein the left context includes one or more previously input words followed by a space or hyphen;
receiving, via a virtual keyboard interface, a user input (A) corresponding to a part of a word,
wherein the word includes the part of the word and another portion of the word;
retrieving, based on the user input (A) corresponding to the part of the word, and without having received the other portion of the word, a list of candidate words matching the user input (A);
modifying the list of candidate words based on one or more conditional probabilities, given the left context words, for one or more of the candidate words;
displaying the modified list of candidate words;
receiving a selection of the word from the displayed modified list of candidate words; and
entering the selected word in the input field.

2. The method of claim 1 further comprising receiving, from a dictionary, the one or more conditional probabilities,
wherein one or more of the conditional probabilities identify the received left context, and
wherein the dictionary is implemented as a local or remote database.

3. The method of claim 1 further comprising receiving, from a dictionary, the one or more conditional probabilities, the conditional probabilities identifying an n-gram.

4. The method of claim 1 wherein receiving a selection of the word from the displayed modified list of candidate words comprises receiving a user input (B) indicating the word in the candidate word list.

5. The method of claim 1 wherein retrieving the list of candidate words is based on conditional probabilities corresponding to the candidate words.

6. The method of claim 1 wherein the left context is an n-gram comprising two or more words.

7. The method of claim 1 further comprising:
receiving one or more linguistic rules corresponding to the received left context; and
calculating, using one or more of the linguistic rules, one or more of the conditional probabilities by:
determining, based on one or more of the linguistic rules, an expected type of word for the received left context; and
comparing the expected type of word with one or more types identified for words on the candidate word list.

8. The method of claim 1 further comprising:
receiving one or more linguistic rules corresponding to the received left context; and
calculating, using one or more of the linguistic rules, one or more of the conditional probabilities.

9. The method of claim 1 wherein the received conditional probability is an estimation of the probability that a user intended the word given the left context.

10. The method of claim 1 wherein modifying the list of candidate words comprises reordering one or more of the candidate words within the list.

11. The method of claim 1 wherein modifying the list of candidate words comprises assigning one or more values corresponding to conditional probabilities to one or more of the candidate words within the list.

12. The method of claim 1 wherein modifying the list of candidate words comprises capitalizing one or more of the candidate words.

13. The method of claim 1 wherein the received conditional probabilities are based on an analysis of a sample of writings.

14. A computer-readable storage medium storing instructions that, when executed by a computing device, cause the computing device to perform operations for entering text in an input field, the operations comprising:
receiving a context for the input field, wherein the context includes data previously input by a user;
receiving, via a touchscreen keyboard interface, a user input (X) corresponding to a part of a word (M),
wherein the word corresponds to an input comprising the part of a word (M) and another portion (N);
retrieving, based on the user input (X) corresponding to the part of a word (M), and without having received the portion (N), a list of candidate words matching the user input (X);
determining, for one or more words in the list of candidate words, that the candidate word has a probability above a predetermined threshold of being capitalized based on the received context;
capitalizing the determined one or more words in the list of candidate words;
displaying the list of candidate words;
receiving a user input (Y) selecting the word from the displayed list of candidate words; and
entering the selected word in the input field.

15. The computer-readable storage medium of claim 14 wherein the user input (Y) is one of: a space or punctuation character, an end gesture, and a selection within the list of candidate words.

16. The computer-readable storage medium of claim 14 wherein the context consists of an immediately preceding entered word and wherein the operations further comprise;
identifying a right context for a previously entered word or phrase, the right context comprising one or more words entered by the user after the previously entered word or phrase;
determining that the previously entered word or phrase should be modified based on a determined probability being above a pre-defined threshold that the user intended a different input; and
modifying the previously entered word or phrase based on a determination for the intended different input, wherein the modifying comprises changing one or more of: word spelling, grammar, and punctuation.

17. The computer-readable storage medium of claim 14 wherein the probability is determined by comparing an expected type of word with types of words assigned to one or more of the words in the list of candidate words.

18. A system for entering text in an input field, the system comprising:
an input data storage configured to store a left context, the context based on previous user input;
an input interface configured to receive a first user input;
a candidate selector configured to receive the first user input and select, based on the first user input, a list of candidate words matching the first user input;
a candidate list modifier configured to:
receive the candidate list and one or more conditional probabilities based on the left context; and
modify the list of candidate words based on the conditional probabilities; and
a display configured to display the modified list of candidate words;
wherein the input interface is further configured to receive a second user input indicating a word from the displayed modified list of candidate words; and
wherein the input data storage is further configured to receive and store the selected candidate word.

19. The system of claim 18 wherein:
the input interface is a virtual keyboard interface, and
the candidate list modifier is further configured to modify the list of candidate words by adding formatting to one or more candidate words that correspond to a conditional probability being above a predetermined threshold.

20. The system of claim 18 wherein the left context is a list of ordered previously entered words from the input data storage delineated by a one or more predetermined punctuation marks.
